(19) United States
(12) Patent Application Publication
(10) Pub. No.: US 2014/0022382 A1
(43) Pub. Date: Jan. 23, 2014

(54) VIDEO SETTING METHOD

(71) Applicant: VIVOTEK INC., New Taipei City (TW)

(72) Inventors: Chien-Wen LIU, New Taipei City (TW); Tao-Cheng YANG, New Taipei City (TW)

(73) Assignee: VIVOTEK INC., New Taipei City (TW)

(21) Appl. No.: 13/846,237

(22) Filed: Mar. 18, 2013

(30) Foreign Application Priority Data
Jul. 18, 2012 (TW) 101125942

(51) Int. Cl. H04N 7/18

(52) U.S. Cl. CPC H04N 7/181
USPC 348/143

(57) ABSTRACT

A video setting method is applicable to a video player. The video setting method includes the following steps: receiving a plurality of videos at the same time; acquiring identification information of each of the videos; according to a playing mode, deciding a playing type of the video player; generating at least one playing frame, the at least one playing frame including at least one playing window, and according to the identification information, filling the videos into the at least one playing window in the at least one playing frame; and according to the playing type, playing the videos in the at least one playing window on the video player.

### CROSS-REFERENCE TO RELATED APPLICATIONS

This non-provisional application claims priority under 35 U.S.C. §119(a) on Patent Application No(s). 101125942 filed in Taiwan, R.O.C. on Jul. 18, 2012, the entire contents of which are hereby incorporated by reference.

### BACKGROUND

1. Technical Field

The disclosure relates to a video setting method, and more particularly to a video setting method that automatically arranges and plays videos.

2. Related Art

With the development of science and technology, a monitoring system is used more and more widely in people's daily lives. In recent years, in addition to being widely applied in office buildings, a monitoring system also starts its use in apartments with building janitors for security.

Generally speaking, a monitoring system usually includes a plurality of cameras to capture videos of various locations to perform monitoring. In the monitoring system, a plurality of monitoring windows is usually displayed at the same time in a display in the manner of split screen, so as to reduce the number of displays to be used. Each monitoring window displays a video captured by a single camera, respectively.

However, a number of complex operations are often required to display videos captured by cameras on the monitor windows, that is, a user needs to drag videos into corresponding monitor windows one by one to display each video on the corresponding monitoring window. The complex operations increase the time spent by the user to set and play videos. Therefore, the setting manner of configuring videos on corresponding monitoring windows still needs to be improved.

### SUMMARY

In view of the above problem, the disclosure is to provide a video setting method, so as to reduce the time for video playing setting and enhance the convenience of use.

A video setting method in the disclosure is applicable to a video player. The video setting method comprises the following steps: receiving a plurality of videos at the same time; acquiring identification information of each of the videos; according to a playing mode, deciding a playing type of the video player; generating at least one playing frame, the at least one playing frame comprising at least one playing window, and according to the identification information, filling the videos into the at least one playing window in the at least one playing frame; and according to the playing type, playing the videos in the at least one playing window on the video player.

In an embodiment, the generated at least one playing frame and the at least one playing window comprised therein are a layout of a layout set.

In an embodiment, the generated at least one playing frame and the at least one playing window comprised therein are generated automatically according to the number of the videos and the playing type.

In an embodiment, the playing mode is that each of the playing windows plays one of the videos through the video player, and the playing type is to play the videos in the playing windows one-to-one in sequence.

In an embodiment, the step of filling the videos into the playing window into the at least one playing frame comprises the following steps: according to the identification information, arranging a playing priority sequence corresponding to all the videos; according to the playing priority sequence, establishing a video filling list; according to the video filling list, selecting a plurality of videos to be filled into the single playing window; generating at least one playing frame, the amount of the playing windows in each of the playing frame being one; and according to the playing priority sequence, filling the selected videos into the single playing window of the at least one playing frame.

In an embodiment, the playing mode is that the video player plays the videos in a plurality of playing windows, and the playing type is that the video player displays the playing windows, in which the playing windows are presented in a layout form.

In an embodiment, the step of filling the videos into the playing windows into the at least one playing frame comprises the following steps: according to the identification information, establishing a video filling list; according to the video filling list, selecting a plurality of videos to be filled into the playing windows of the at least one playing frame; generating at least one playing frame, the at least one playing frame corresponding to the plurality of playing windows, the playing windows corresponding to the identification information, respectively; according to the identification information of the selected videos, filling the selected videos into the corresponding playing windows of the at least one playing frame, respectively; detecting whether all the selected videos have been filled; if it is detected that all the selected videos have been filled, entering the step of according to the playing type, playing the videos in the at least one playing window on the video player; and if it is detected that all the selected videos have not been filled, generating another same at least one playing frame and corresponding playing windows thereof, and filling the rest selected videos.

A video setting method of the disclosure is applicable to a plurality of video players. The video setting method comprises: receiving a plurality of videos at the same time; acquiring respective identification information of the videos; according to a playing mode, deciding respective playing types of the video players, generating at least one playing frame, the at least one playing frame comprising a plurality of playing windows respectively, and the playing windows comprised in the at least one playing frame corresponding to the identification information and the video players, and according to the identification information, filling the videos into the playing windows into the at least one playing frame; and according to the playing type, playing the videos in the playing windows on the video players.

In an embodiment, the playing mode is that the video players play the videos in a plurality of playing windows, and the playing type is that the video players display the playing windows, respectively, in which the playing windows are presented in a layout form.

In an embodiment, the step of filling the videos into the corresponding the playing windows into the at least one playing frame comprises the following steps: according to the identification information, establishing a video filling list; according to the video filling list, selecting a plurality of videos to be filled into the playing windows of the at least one playing frame; generating at least one playing frame, the at least one playing frame comprising the playing windows, the playing windows corresponding to the identification information, respectively; according to the identification information of the selected videos, filling the selected videos into the corresponding playing windows of the at least one playing frame, respectively; detecting whether all the selected videos have been filled; if it is detected that all the selected videos have been filled, entering the step of according to the playing type, playing the videos in the playing windows on the video players; and if it is detected all the selected videos have not been filled, generating another same at least one playing frame and corresponding playing windows thereof, and filling the rest selected videos.

In an embodiment, for the playing windows, the video players display the same number of playing windows or different numbers of playing windows.

In the video setting method of the disclosure, corresponding playing frames and playing windows thereof are generated automatically according to a plurality of received videos, and the videos are automatically filled in the playing windows of the corresponding playing frames one by one to play the videos cyclically. Therefore, the time for a user to set videos generated by video cameras one by one, that is, to drag videos into corresponding playing windows, can be effectively reduced, so as to reduce the time for the video playing setting and enhance the convenience of use.

### BRIEF DESCRIPTION OF THE DRAWINGS

The disclosure will become more fully understood from the detailed description given herein below for illustration only, and thus does not limit the disclosure, wherein:

FIG. 1 is a flow chart of a video setting method of the disclosure;

FIG. 2 is a schematic diagram of various types of playing windows of the disclosure;

FIG. 3 is a schematic diagram of a playing frame and the generation of playing windows thereof of the disclosure;

FIG. 4 is another schematic diagram of a playing frame and the generation of playing windows thereof of the disclosure;

FIG. 5 is a detailed flow chart of Step S108 of the disclosure;

FIG. 6 is another detailed flow chart of Step S108 of the disclosure;

FIG. 7 is a flow chart of another video setting method of the disclosure;

FIG. 8 is a schematic diagram of another playing frame and playing thereof of the disclosure;

FIG. 9 is a detailed flow chart of Step S708 of the disclosure; and

FIG. 10 is a schematic diagram of yet another video setting method of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

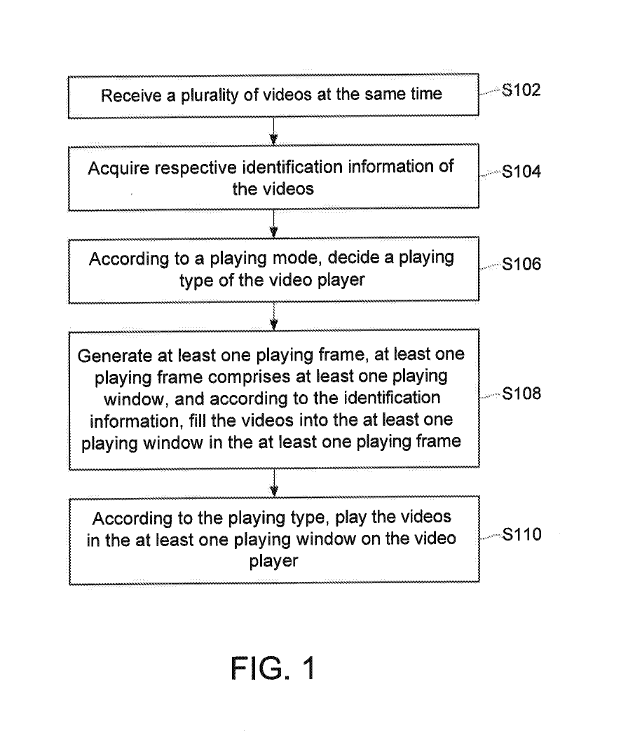

Referring to FIG. 1, FIG. 1 is a flow chart of a video setting method of the disclosure. The video setting method of the disclosure is applicable to a video player, and the video player, for example, has a display and a processing device, and the processing device is, for example, a computer. The display is used for displaying related videos and corresponding processing results of the processing device. The processing device is used for processing the videos generated by video cameras and related operations of the video player.

First, in Step S102, a plurality of videos is received at the same time. For example, these videos, for example, correspond to a plurality of video cameras one-to-one, or the processing device performs video processing to generate a plurality of videos corresponding to one video camera. That is, each video camera generates one video, or the processing device processes the output of one video camera to generate a plurality of videos. Also, the video player, for example, is connected to the plurality of video cameras, so that the video player receives a plurality of videos generated by the video cameras at the same time.

In Step S104, respective identification information of the videos is acquired. For example, each of the video cameras has an identification code, and the video camera attaches the identification code to the video generated thereby, for example, a header of the video. Therefore, when the video player acquires the videos generated by the video cameras, the processing device of the video player is capable of obtaining the respective identification information of the plurality of videos according to the identification codes in the headers of the videos, so that the video player is capable of distinguishing which video corresponds to which video camera (that is, which video is generated by which video camera).

In Step S106, according to a playing mode, a playing type of the video player is decided. The playing mode is, for example, preset in the video player, or the playing mode is selected by a user. Then, the processing device of the video player, according to the preset playing mode or the playing mode selected by the user, decides the playing type of the video player, and displays the playing type on the display of the video player. That is, in Step S106, it is decided in which playing type the video player plays the plurality of videos generated by the video cameras.

Next, in Step S108, at least one playing frame is generated. The at least one playing frame comprises at least one playing window. And, according to the identification information, the videos are filled into the at least one playing window in the at least one playing frame.

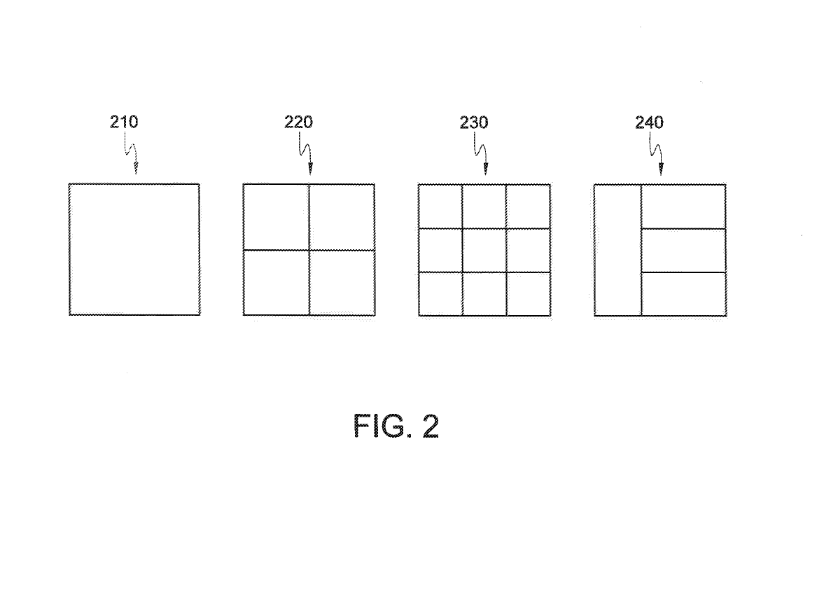

In this embodiment, the generated at least one playing frame and the at least one playing window comprised therein in Step S108 are a layout of a layout set. That is, the at least one playing window is, for example, a layout of a square array of 1*1. (for example, the label 210 shown in FIG. 2), 2*2 (for example, the label 220 shown in FIG. 2), 3*3 (for example, the label 230 shown in FIG. 2), or a layout of a non-square array (for example, the label 240 shown in FIG. 2), but the disclosure is not limited thereto, and the preset layout may also be adjusted by a user to other types as demanded.

Also, the generated at least one playing frame and the at least one playing window comprised therein in Step S108 are automatically generated according to the number of the videos and the playing type. That is, the processing device of the video player further counts the number of the received videos, and in combination with the decided playing type, generates playing frames of the corresponding number, and the playing windows comprised in the playing frames.

For example, in an embodiment, the playing type is a 1*1 square array, and the number of the videos is 10, so the processing device of the video player automatically generates 10 playing frames 310_1, 310_2, . . . , and 310_10 correspondingly, and the 10 playing frames 310_1, 310_2, . . . , 310_10 comprise 1 playing window, respectively, as shown in FIG. 3. Next, the video player fills the 10 videos into the playing windows in the corresponding 10 playing frames one-to-one.

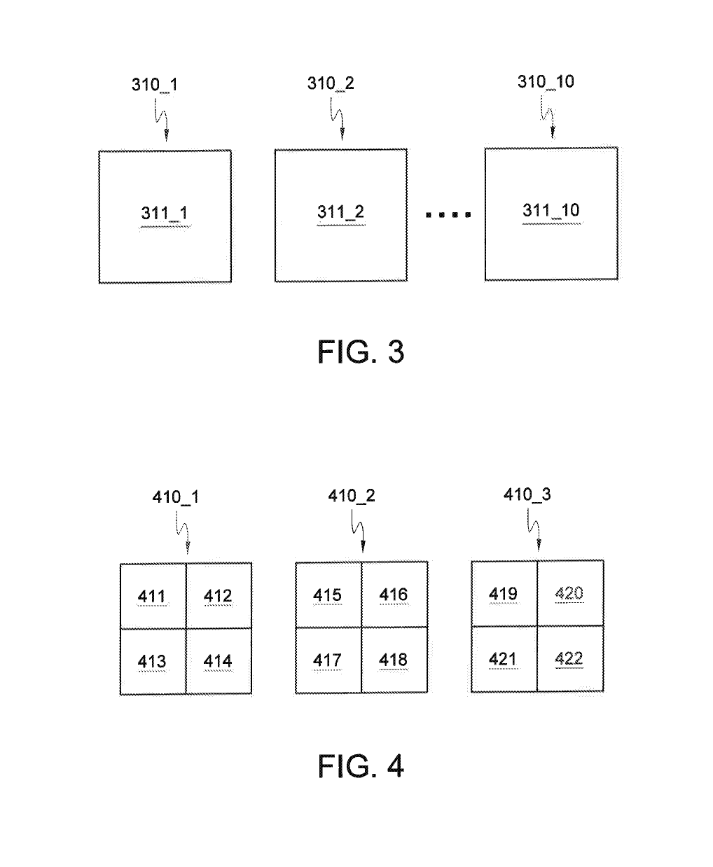

In another embodiment, the playing type is a 2*2 square array, and the number of the videos is 10, so that the processing device of the video player automatically generates 3 playing frames 410_1 to 410_3, and the 3 playing frames 410_1 to 410_3 comprise 4 playing windows respectively (that is, the playing windows of the 2*2 square array), as shown in FIG. 4. Next, the video player fills the 10 videos into the playing windows in the corresponding 3 playing frames one-to-one. The embodiment only gives the two implementation examples listed in the disclosure, but the disclosure is not limited thereto, and other embodiments may also be comprised, and other implementation examples may be derived from the listed implementation examples, which are therefore no longer elaborated here.

In Step S110, according to the playing type, the video in the at least one playing window are displayed on the video player. That is, according to the video playing setting result, on the display of the video player, the videos in the playing windows of the corresponding playing type are displayed. For example, the videos are played one by one in sequence in the type in FIG. 3 or FIG. 4. Therefore, the time spent by the user to set videos generated by the video cameras one by one, that is, to drag videos into the corresponding playing windows, can be effectively reduced, so as to reduce the time for video setting and enhance the convenience of use.

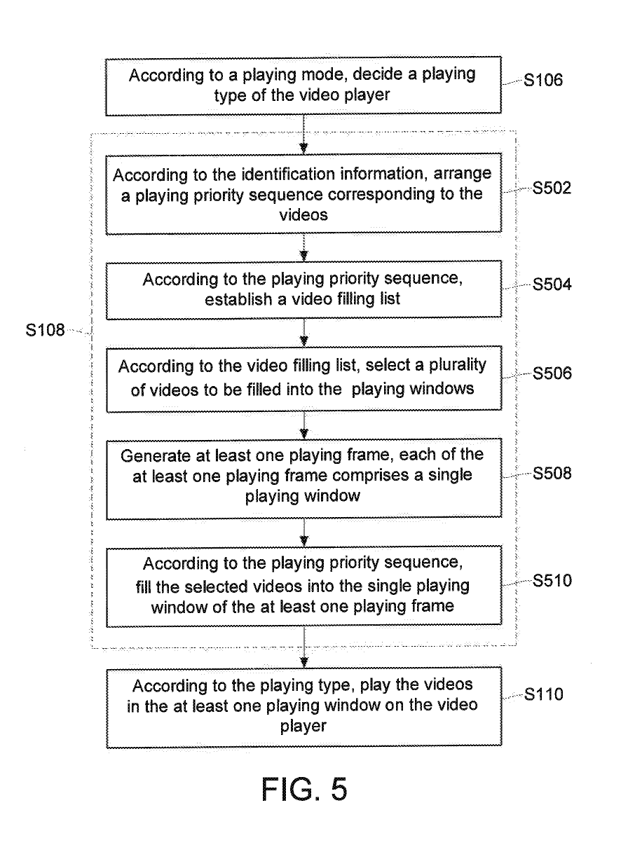

In this embodiment, the playing mode is that the video player plays one video in a single playing window, the playing type is to play the videos in sequence in the playing windows one-to-one, and the playing windows are, for example, the playing window 311_1, 311_2, . . . , or 311_10 shown in FIG. 3, Step S108 further comprises the following steps, as shown in FIG. 5.

Referring to FIG. 5, FIG. 5 is a detailed flow chart of Step S108 of the disclosure. First, in Step S502, according to the identification information, a playing priority sequence corresponding to the videos is arranged. For example, the processing device of the video player acquires the identification information corresponding to the identification codes of the video cameras, and then for example, according to the sequence of the English words or the values of the number codes in the identification information, decides and arranges a playing priority sequence of the videos, that is, to play which video first, and to play which video next. For example, the number of the videos is 10, the videos are A, B, E, D, G, C, H, F, J, and I, respectively, and after the processing by the processing device of the video player, the playing priority sequence of videos is, the videos A, B, C, D, E, F, G, H, I, and J.

In Step S504, according to the playing priority sequence, a video filling list is established. For example, when the playing priority sequence is decided and arranged, the processing device of the video player establishes the video filling list, and displays the video filling list on the display of the video player.

In Step S506, according to the video filling list, a plurality of videos to be filled into the single playing window is selected. For example, the user, based on the video filling list displayed on the display of the video player, selects the number of the videos to be filled into the playing windows.

In Step S508, at least one playing frame is generated, and each of the at least one playing frame comprises a single playing window. If the user selects only one video to be filled, for example, the video C, the processing device of the video player, for example, generates 1 playing frame 310_1, and the playing frame 310_1 comprises a single playing window 311_1. If the user selects 5 videos to be filled, for example, videos A to E, the processing device of the video player, for example, generates 5 playing frames 310_1 to 310_5, and these playing frames 310_1 to 310_5 comprise single playing windows 311_1 to 310_5, respectively. If the user selects 10 videos to be filled, for example, videos A to J, the processing device of the video player, for example, generates 10 playing frames 310_1 to 310_10, and these playing frames 310_1 to 310_10 comprise single playing windows 311_1 to 310_10, respectively.

In Step S510, according to the playing priority sequence, the selected videos are filled in the single playing window of the at least one playing frame. Next, after the videos are filled in the single playing windows of the corresponding playing frames, the processing device of the video player outputs the videos of the single playing windows of the corresponding playing frames in sequence, so as to play the videos cyclically on the display of the video player.

For example, when the selected video is the video C, the processing device of the video player fills the video C into the single playing window 311_1 of the playing frame 310_1. Next, the processing device of the video player outputs the video C of the single playing window 311_1 of the playing frame 310_1, so as to play the video C on the display of the video player.

When the selected videos are videos A to E, and the playing priority sequence is also videos A to E, the processing device of the video player fills the video A into the single playing window 311_1 of the playing frame 310_1, fills the video B into the single playing window 311_2 of the playing frame 310_2, and fills the video E into the single playing window 311_5 of the playing frame 310_5 in sequence. Next, the processing device of the video player outputs the videos A to E of the single playing windows 311_1 to 311_5 of the playing frames 310_1 to 310_5, so as to play the videos A to F on the display of the video player cyclically.

When the selected videos are videos A to J, and the playing priority sequence is also videos A to J, the processing device of the video player fills the video A into the single playing window 311_1 of the playing frame 310_1, fills the video B into the single playing window 311_2 of the playing frame 310_2, . . . , fills the video E into the single playing window 311_5 of the playing frame 310_5, . . . , and fills the video J into the single playing window 311_10 of the playing frame 310_10 in sequence. Next, the processing device of the video player outputs the videos A to J of the single playing windows 311_1 to 311_10 of the playing frames 310_1 to 310_10, so as to play the videos A to J cyclically on the display of the video player.

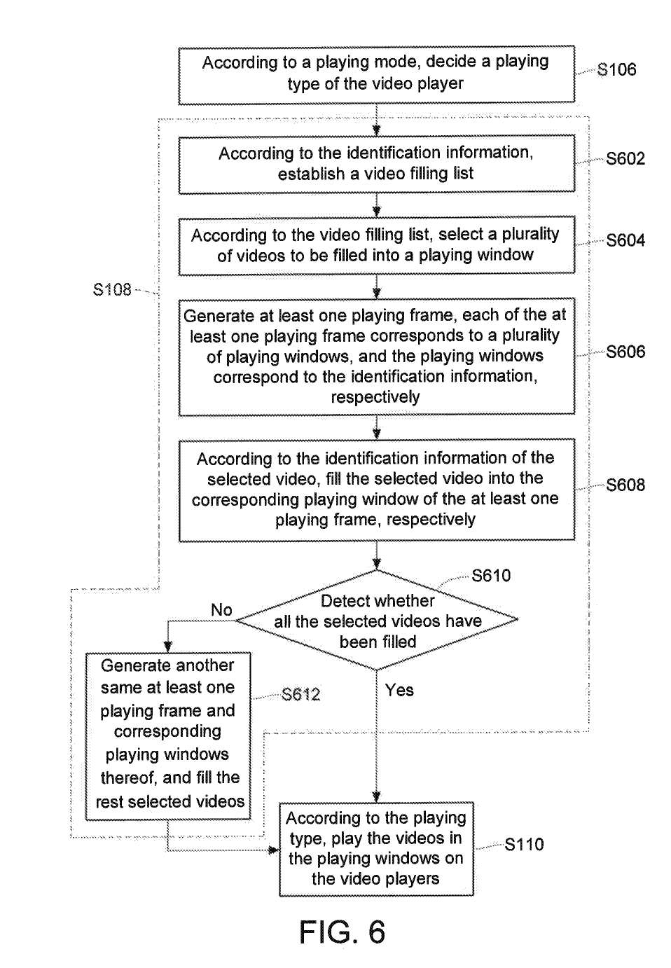

In another embodiment, the playing mode is that the video player plays the videos on the at least one frame and each of the at least one frame comprises a plurality of playing windows, and the playing type is that the video player displays at least one frame and each of the at least one frame comprises the plurality of playing windows. The plurality of playing windows is presented in a layout form, for example, a layout form formed of playing windows 411, 412, 413, and 414 shown in FIG. 4. Step S108 further comprises the following steps, as shown in FIG. 6,

Referring to FIG. 6, FIG. 6 is another detailed flow chart of Step S108 of the disclosure. In Step S602, according to the identification information, a video filling list is established. For example, the processing device of the video player acquires the identification information corresponding to the identification code of the video camera. Then, according to the sequence of the English words or the values of the number codes in the identification information, decides and arranges a playing priority sequence of the videos, that is, to display which video first, and to display which video next.

For example, the number of the videos is 10, which are respectively videos A, B, E, D, G, C, H, F, J, and I, so after the processing of the processing device of the video player, the playing priority sequence of the videos is videos A, B, C, D, E, F, G, H, I, and J. Also, when the playing priority sequence is decided and arranged, the processing device of the video player establishes a video filling list, and displays the video filling list on the display of the video player.

In Step S604, according to the video filling list, a plurality of videos to be filled into playing window is selected, wherein each of the windows is filled with one of the videos. For example, a user, based on the video filling list displayed on the display of the video player, selects the number of the videos to be filled into the playing window.

In Step S606, at least one playing frame is generated. Each of the at least one playing frame corresponds to a plurality of playing windows, and the playing windows correspond to the identification information, respectively. In this embodiment, the processing device of the video player generates a playing frame 410_1 first, and the playing frame 410_1 comprises 4 playing windows 411, 412, 413, and 414.

In Step S608, according to the identification information of the selected videos, the selected video are filled into the corresponding playing window of the at least one playing frame, respectively. If only one video, for example, a video C, is selected, the processing device of the video player fills the video C into the playing window 411 of the playing frame 410_1, and the playing window 411 corresponds to the identification information of the video C.

If 5 videos are selected, for example, videos A to E, the processing device of the video player fills the videos A to D into the playing windows 411 to 414 of the playing frame 410_1, respectively, so that the rest video E is not filled in the playing frame 410_1. If 10 videos are selected, for example, videos A to J, the processing device of the video player fills the videos A to D into the playing frames 411 to 414, and the videos E to J are not filled into the playing frame 410.

In Step S610, it is detected whether all the selected videos have been filled in the playing windows. If it is detected that all the selected videos have been filled, enter Step S110 of according to the playing type, playing the videos on the at least one playing window on the video player. For example, when the selected video is merely the video C, in Step S610, it is detected that the selected videos have been filled into the playing windows. Then, the processing device of the video player outputs the video C of the playing window 411 of the playing frame 410_1, so as to play the video C of the playing frame on the display of the video player.

If it is detected that at least one of the selected videos has not been filled into the playing windows, enter Step S612 of generating another same playing frame with corresponding playing windows thereof, and filling the rest selected videos into the playing windows of the another same playing frame. Next, after all the videos have been filled into the windows, enter Step S110 of according to the playing type, playing the videos in the playing windows on the video player.

If 5 videos, for example, videos A to E, are selected, after Step S608 is performed, the video E is not filled into the playing windows of the playing frame 410_1. Next, in Step S610, it is determined that the selected videos have not been filled into the playing windows of the playing frame 410_1. Therefore, the processing device of the video player further generates a playing frame 410_2 same as the playing frame 410_1. That is the playing frame 410_2 comprises 4 playing windows 415, 416, 417, and 418. Subsequently, the processing device of the video player fills the rest video E into the playing window 415 of the playing frame 410_2. Next, the processing device of the video player outputs the videos A to E of the single playing windows 411 to 415 of the playing frames 410_1 and 410_2, so as to play the videos A to E on the display of the video player cyclically.

If 10 videos, for example, videos A to J, are selected, after Step S608 is performed, the videos E to J are not filled into the playing windows of the playing frame 410_1. Next, in Step S610, it is determined that some of the selected videos have not been filled into the playing windows of the playing frame 410_1. Because 6 videos E to J are left and a playing frame has 4 video windows, the processing device of the video player further generates two more playing frames 410_2 and 410_3 same as the playing frame 410_1. The playing frames 410_2 comprise 4 playing windows 415, 416, 417, and the playing frames 410_3 comprises 4 playing windows 418 and 419, 420, 421, and 422.

Subsequently, the processing device of the video player fills the videos E to H into the playing windows 415, 416, 417, and 418 of the playing frame 410_2, and the videos I and J are filled into the playing windows 419 and 420 of the playing frame 410_3. Next, the processing device of the video player outputs the videos A to J of the playing windows 411 to 420 of the playing frames 410_1, 410_2, and 410_3, so as to play the videos A to J on the display of the video player cyclically.

In the above mentioned embodiments, a single video player is taken as an example to perform video playing setting in the embodiments, but the disclosure is not limited thereto.

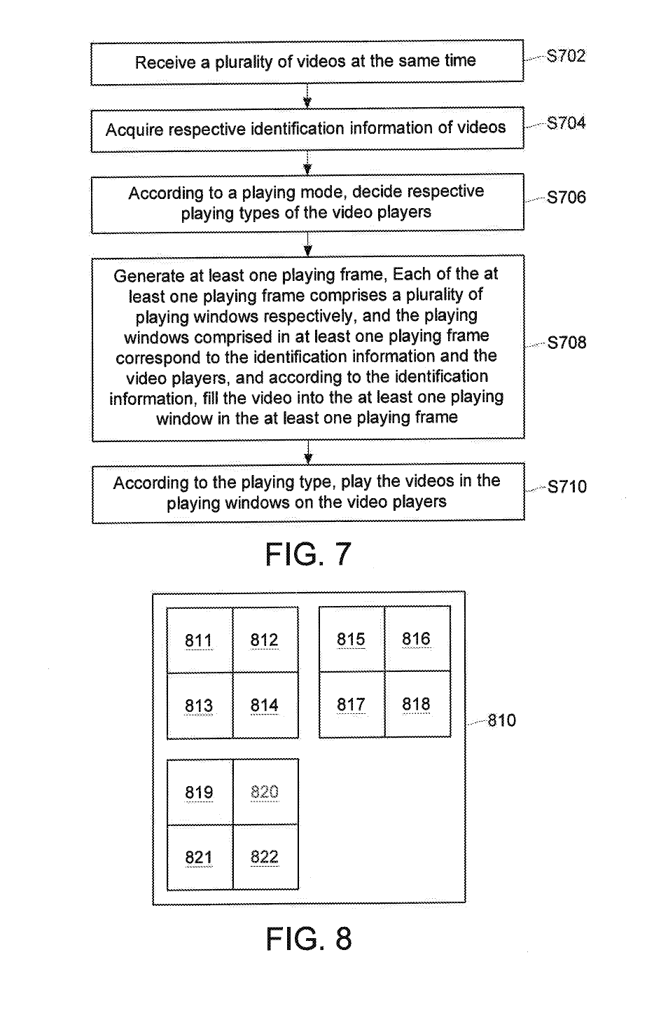

Referring to FIG. 7, FIG. 7 is a flow chart of a video setting method of the disclosure. The video setting method of the disclosure is applicable to a plurality of video players. In an embodiment, these video players, for example, have a display, respectively. These video players, for example, share one processing device, and the processing device is, for example, a computer. The display is used for displaying related videos and corresponding processing results of the processing device. The processing device is used for processing videos generated by video cameras and related operations of the plurality of video players. Also, the combination of these video players can form a video wall.

First, in Step S702, a plurality of videos is received at the same time. For example, these videos, for example, correspond to a plurality of video cameras one-to-one, or the processing device performs video processing to generate a plurality of videos corresponding to one video camera. That is, each video camera generates a video, or each video camera generates a plurality of videos through the processing device performing video processing. Also, the video players, for example, are connected to the plurality of video cameras, so that the video players receive the plurality of videos generated by the video cameras at the same time.

In Step S704, respective identification information of videos is acquired. For example, the plurality of video cameras has an identification code, respectively, and the video camera attaches the identification code to the video generated by the video camera, for example, a header of the video. Therefore, when the video players acquire the videos generated by the video cameras, the processing device of the video players obtains the identification information of the plurality of videos respectively according to the identification codes in the headers of the videos, so that the video players learn which video corresponds to which video camera (that is, which video is generated by which video camera).

In Step S706, according to a playing mode, respective playing types of the video players are decided. The playing mode is, for example, preset in these video players, or is a playing mode selected by a user as demanded. Therefore, the processing device of the video players decides a playing type of a video player according to the preset playing mode or the playing mode selected by the user, and the playing type is displayed on the displays of the video players. That is, it is decided in which playing type the video players play the plurality of videos generated by the video cameras.

In Step S708, at least one playing frame is generated. Each of the at least one playing frame comprises a plurality of playing windows, and the playing windows comprised in at least one playing frame correspond to the identification information and the video players, and according to the identification information, the video is filled into the at least one playing window in the at least one playing frame.

In this embodiment, the at least one playing frame and the plurality of playing windows comprised therein generated in Step S708 are a layout of a layout set. For example, the playing windows, for example, may be a layout type of a square array such as 1*1 (for example, the label 210 shown in FIG. 2), 2*2 (for example, the label 220 shown in FIG. 2), 3*3 (for example, the label 230 shown in FIG, 2), or a layout type of a non-square array (for example, the label 240 shown in FIG. 2), but the disclosure is not limited thereto, and the preset layout type may also be adjusted by a user to other types as demanded.

Also, the at least one playing frame and the plurality of playing windows comprised therein generated in Step S708 are generated automatically according to the number of the videos and the playing type. That is, the processing device of the video players further counts the number of the received videos, and in combination with the decided playing type, generates playing frames of the corresponding number and the playing windows comprised in the playing frames.

For example, in an embodiment, 3 video players are provided, the playing type of the video players is a 2*2 square array, and the number of the videos is 10, so that the processing device of the video players automatically generates 1 playing frame 810 correspondingly, and the playing frame 810 comprises 12 playing windows (that is, 3 2*2 square-array of playing windows) 811 to 822, as shown in FIG. 8. Also, the playing windows 811 to 814, 815 to 818, and 819 to 822 correspond to the 3 video players, respectively. Next, the video players fill 10 videos into 10 playing windows in the corresponding playing frames one-to-one, for example, playing windows 811 to 820.

In another embodiment, the number of videos is 15, so that the processing device of the video players automatically generates 2 same playing frames 810 correspondingly, and the 2 playing frames 810 comprise 12 playing windows (that is, 2*2 square arrays of playing windows) 811 to 822, respectively. Next, the video players fill the 12 videos into the playing windows 811 to 822 in the corresponding first playing frame 810 one-to-one, and fills the rest 3 videos into the playing windows 811 to 813 in the corresponding second playing frame 810 one-to-one. The embodiment only gives two implementation examples listed in the disclosure, but the disclosure is not limited thereto, and other embodiments may also be comprised, and other implementation examples may be derived from the listed implementation examples, which are therefore no longer elaborated here.

In Step S710, according to the playing type, the videos in the playing windows are played on the video players. That is, according to the video playing setting result, the videos in the playing windows in the corresponding playing type are displayed on the displays of the video players. Therefore, the time for a user to set the videos generated by the video cameras one by one, that is, to drag the videos in the corresponding playing windows, can be effectively reduced, so as to reduce the time spent in video playing setting and enhance the convenience of use.

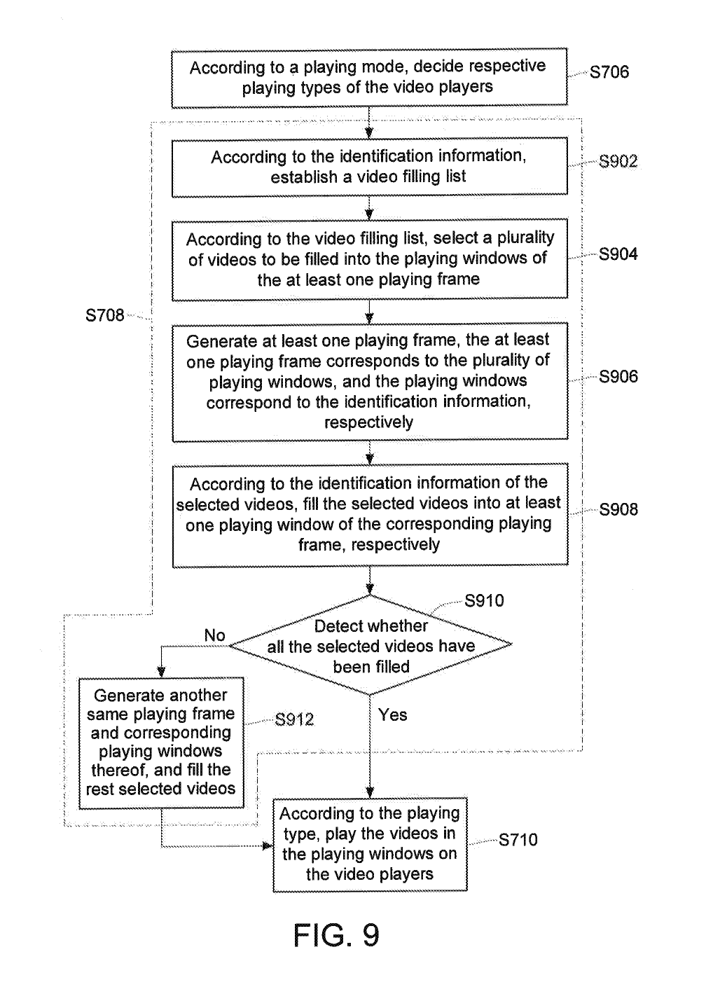

In this embodiment, the playing mode is that these video players play the videos with a plurality of playing windows, and the playing type is that these video players display a plurality of playing windows, respectively, wherein the playing windows are presented in a layout form, as shown in FIG. 9. Step S708 further comprises the following steps, as shown in FIG. 9.

In Step S902, according to the identification information, a video filling list is established. The processing device of the video players acquires the identification information corresponding to the identification codes of the video cameras, for example, according to the sequence of the English words or the values of the number codes in the identification information, decides and arranges the playing priority sequence of the videos, that is, to play which video first, and to play which video next.

If the number of the videos is 15, the videos are A, B, E, D, G, C, H, F, J, I, K, L, M, O, and N, respectively, and after the processing device of the video players performs processing, the playing priority sequence of the videos is, for example, videos A, B, C, D, E, F, G, H, I, J, K, L, M, N, and O. Also, when the playing priority sequence is decided and arranged, the processing device of the video players establishes a video filling list, and displays the video filling list on the displays of the video players.

In Step S904, according to the video filling list, a plurality of videos to be filled into the playing windows of the at least one playing frame is selected. For example, a user, based on the video filling list displayed on the displays of the video players, selects the number of the videos to be filled into the single playing window.

In Step S906, at least one playing frame is generated, the at least one playing frame corresponds to the plurality of playing windows, and the playing windows correspond to the identification information, respectively. That is, the processing device of the video players first generates a playing frame 810, and the playing frame 810 corresponds to 12 playing windows 811 to 822.

In Step S908, according to the identification information of the selected videos, the selected videos are filled into at least one playing window of the corresponding playing frame, respectively. If 10 videos, for example, videos A to J, are selected, the processing device of the video players, for example, fills the videos A to J into the playing windows 811 to 820 of the playing frame 810, and the playing windows 811 to 820 correspond to the identification information of the videos A to J.

If 15 videos, for example, videos A to O, are selected, the processing device of the video players, for example, fills the videos A to L into the playing windows 811 to 822 of the playing frame 810, respectively, and the rest videos M to O are not filled in the playing frame 810.

In Step S910, it is detected whether all the selected videos have been filled. If it is detected that all the selected videos have been filled, enter Step S710 of playing the videos in the playing windows on the video players. For example, when the selected videos are videos A to J, it is detected that all the selected videos have been filled in Step S910, and the processing device of the video players outputs the videos A to J of the playing windows 811 to 820 of the playing frame 810, so as to play the videos A to J in the playing frames on the displays of the video players.

If it is detected that not all of the selected videos has been filled into the windows of the playing frame, enter Step S912 of generating another same playing frame and corresponding playing windows thereof, and the rest selected videos are filled into the playing windows of the another playing frame. Next, after all the videos have been filled into the playing windows, enter Step S710 of according to the playing type, playing the videos in the plurality of playing windows on the plurality of video players.

If 15 videos, for example, videos A to O, are selected, after Step S908 is performed, the videos M to O are not filled, and next in Step S910 it is determined that not all of the selected videos has been filled. Therefore, the processing device of the video players further generates a second playing frame 810 same as the first playing frame 810, and the second playing frame 810 comprises 12 playing windows 811 to 822. Subsequently, the processing device of the video players, for example, fills the rest videos M to O into the playing windows 811 to 813 of the second playing frame 810. Next, the processing device of the video players outputs the videos A to L of the playing windows 811 to 822 of the first playing frame 810, and outputs the videos M to O of the playing windows 811 to 813 of the second playing frame 810, so as to play the videos A to O on the displays of the video players cyclically.

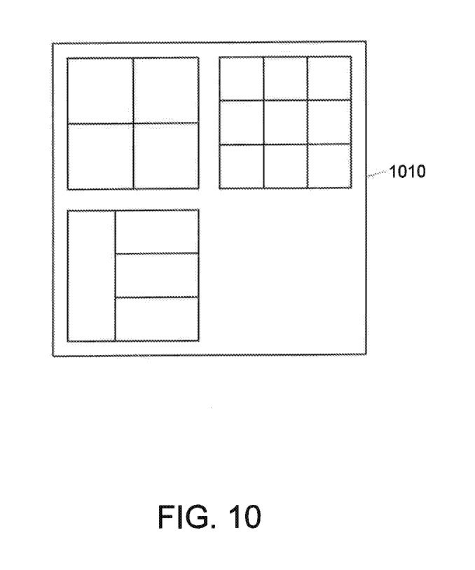

in the embodiment, the video players display the same number of playing windows respectively, that is, the playing frame 810 has 3 2*2 square arrays of playing windows of the same number. However, the disclosure is not limited thereto, and the video players also, for example, display different numbers of playing windows respectively, that is, the playing frame 1010 has 3 playing windows, each having a different number of playing windows, as shown in FIG. 10. The related embodiment in which the video playing setting is taken as an example in FIG. 10 may be referred to the embodiments in FIG. 7 to FIG. 9, and is therefore no longer elaborated here.

In the video setting method in the embodiment of the disclosure, according to a plurality of received videos, corresponding playing frames and playing windows thereof are automatically generated, and these videos are automatically filled in the playing windows of the corresponding playing frame one-to-one, so as to play these videos cyclically. Therefore, the time for a user to set videos generated by video cameras one by one, that is, to drag videos into corresponding playing windows, can be effectively reduced, so as to reduce the time for video playing setting and enhance the convenience of use.

What is claimed is:

1. A video setting method, applicable to a video player, the video setting method comprising:
receiving a plurality of videos at the same time;
acquiring identification information of each of the videos;
according to a playing mode, deciding a playing type of the video player;
generating at least one playing frame, the at least one playing frame comprising at least one playing window, and according to the identification information, filling the videos into the at least one playing window of the at least one playing frame; and
according to the playing type, playing the videos in the at least one playing window on the video player.

2. The video setting method according to claim 1, wherein the generated at least one playing frame and the at least one playing window comprised therein are a preset layout.

3. The video setting method according to claim 1, wherein the generated at least one playing frame and the at least one playing window comprised therein are generated automatically according to the number of the videos and the playing type.

4. The video setting method according to claim 1, wherein the playing mode is that each of the playing windows plays one of the videos through the video player, and the playing type is to play the videos in the playing windows one-to-one in sequence.

5. The video setting method according to claim 4, wherein the step of filling the videos into the playing window of the at least one playing frame comprises:
according to the identification information, arranging a playing priority sequence corresponding to the videos;
according to the playing priority sequence, establishing a video filling list;
according to the video filling list, selecting a plurality of videos to be filled into the single playing window;
generating the at least one playing frame, the amount of the playing windows in each of the playing frame being one; and
according to the playing priority sequence, filling the selected videos into the single playing window of the at least one playing frame.

6. The video setting method according to claim 1, wherein the playing mode is that the video player plays the videos in a plurality of playing windows, and the playing type is that the video player displays the playing windows, wherein the playing windows are presented in a layout form.

7. The video setting method according to claim 6, wherein the step of filling the videos into the playing windows into the at least one playing frame comprises:
according to the identification information, establishing a video filling list;
according to the video filling list, selecting a plurality of videos to be filled into the playing windows of the at least one playing frame;
generating the at least one playing frame, the at least one playing frame corresponding to the playing windows, the playing windows corresponding to the identification information respectively;
according to the identification information of the selected videos, filling the selected videos into the corresponding playing windows of the at least one playing frame respectively;
detecting whether all the selected videos have been filled;
if it is detected that all the selected videos have been filled, entering the step of according to the playing type, playing the videos in the at least one playing window on the video player; and
if it is detected that all the selected videos have not been filled, generating another same at least one playing frame and the corresponding playing windows thereof, and filling the rest selected videos.

8. A video setting method, applicable to a plurality of video players, the video setting method comprising:
receiving a plurality of videos at the same time;
acquiring identification information of the videos;
according to a playing mode, deciding respective playing types of the video players;
generating at least one playing frame, the at least one playing frame comprising a plurality of playing windows respectively, and the playing windows comprised in the at least one playing frame corresponding to the identification information and the video players, and according to the identification information, filling the videos into the playing windows of the at least one playing frame; and
according to the playing type, playing the videos in the playing windows on the video players.

9. The video setting method according to claim 8, wherein the playing mode is that the video players play the videos in the playing windows, the playing type is that the video players display the playing windows respectively, and the playing windows are presented in a layout form.

10. The video setting method according to claim 9, wherein the step of filling the videos into the corresponding playing windows of the at least one playing frame comprises:
according to the identification information, establishing a video filling list;
according to the video filling list, selecting a plurality of videos to be filled into the playing windows of the at least one playing frame;
generating the at least one playing frame, the at least one playing frame comprising the playing windows, the playing windows corresponding to the identification information respectively;
according to the identification information of the selected videos, filling the selected videos into the corresponding playing windows of the at least one playing frame respectively;
detecting whether all the selected videos have been filled;
if it is detected that all the selected videos have been filled, entering the step of according to the playing type, playing the videos in the playing windows on the video players; and
if it is detected all the selected videos have not been filled, generating another same at least one playing frame and the corresponding playing windows thereof, and filling the rest selected videos.

11. The video setting method according to claim 9, wherein the video players display the same number of playing windows or different numbers of playing windows respectively.
